(19) United States
(12) Patent Application Publication
(10) Pub. No.: US 2004/0172550 A1
(43) Pub. Date: Sep. 2, 2004

(54) Security system, information management system, encryption support system, and computer program product

(75) Inventor: Kousetsu Sai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 10/763,275

(22) Filed: Jan. 26, 2004

(30) Foreign Application Priority Data
Feb. 27, 2003 (JP) 2003-051842

(51) Int. Cl. G06F 12/14

(52) U.S. Cl. 713/193

(57) ABSTRACT

An information management system includes a portion for receiving rule information indicating an encryption rule of information defined for each secret level that is a level of wanting to keep information secret and encryption data necessary for encrypting information in accordance with the rule from an encryption support system, a portion for storing classification of information managed by the information management system for each classification in connection with the secret level, a portion for encrypting information managed by the information management system by using the encryption data of the secret level corresponding to the classification of the received information, a portion for storing the encrypted information using the encryption data and a portion for transmitting process information indicating the encryption process to the encryption support system so as to receive a check whether or not the encryption of the information was performed in accordance with the rule.

### BACKGROUND OF THE INVENTION

1. Field of the Invention

The present invention relates to a system for managing encryption of classified information.

2. Description of the Prior Art

Conventionally, various measures have been proposed for preventing leakage of information that is handled in organizations including a company, a school, a government and a municipality. For example, a method is proposed that uses a firewall provided between a network within the organization and a network outside the organization (such as the Internet) so as to restrict or prohibit accesses from the outside to the inside.

However, even if there is a firewall, there is a possibility of attack from the outside if the inside network has a security hole, resulting in leakage of information. There is another possibility that a user (a staff member) who belongs to the organization may leak information due to an operational error. In addition, there is a possibility that a staff member may leak information by fraudulent means. Furthermore, there is a possibility that correctness of information contents is damaged by tampering or falsification.

Therefore, a method is proposed in which information of data is handled after encryption or affixing an electronic signature. According to this method, even if data are leaked to the outside, the contents of the information cannot be checked unless the encryption is decrypted. Thus, the leak of information can be prevented substantially.

However, when adopting the above-mentioned method in a large scale organization including plural local offices, stations, branches or other divisions, it is necessary to provide each division with a special engineer as an administrator who can check technical information (e.g., information about vulnerability of the encryption system that is used currently and information about a latest encryption system) and can implement a security measure (a security policy) in accordance with the technical information. In addition, it is required to maintain a technical level of each administrator above a certain level. As a result, a cost including personnel expenses will increase.

Therefore, it is considered to centralize the management of information that is handled in each division in a system center, for example. In this case, however, traffic between the system center and each division may increase, a load of processes in the system center may increase, and a risk that encryption is decrypted may increase.

For these circumstances, there are many cases where the above-mentioned encryption system is not used effectively in a large scale organization.

On the other hand, in a small organization (e.g., in a SOHO), the good use of the above-mentioned encryption system is neither realized in many cases. It is because that obtaining technical information about encryption as well as implementing a security measure is difficult and such works do not pay if quantity of information to be handled is small.

Therefore, it is considered to commission (outsource) information management to an outside firm. However, since there is a possibility of leaking information via the firm, many businesspersons may desire to manage important classified information within the organization.

### SUMMARY OF THE INVENTION

An object of the present invention is to provide an information management system in which each division can manage information while maintaining a high level of security.

According to one aspect of the present invention, a security system includes an information management system for managing information and an encryption support system for supporting encryption of information in the information management system. The encryption support system is provided with an encryption rule storing portion for storing rule information that indicates an encryption rule of the information for each secret level that is a level of wanting to keep information secret, an encryption data transmitting portion for transmitting encryption data that is necessary for encrypting information in accordance with the rule to the information management system, a process information receiving portion for receiving process information that indicates the encryption process performed by the information management system from the information management system, a monitoring portion for monitoring whether or not the encryption of information is performed in accordance with the rule by the information management system on the basis of the process information received from the information management system, and a warning portion for warning the information management system that was found to encrypt information not in accordance with the rule by the monitoring portion to do encryption of information in accordance with the rule. The information management system is provided with an encryption data receiving portion for receiving the encryption data from the encryption support system, a classification secret level storing portion for storing classification of information managed by the information management system in connection with the secret level for each of the classification, an encrypting portion for encrypting information managed by the information management system by using the encryption data of the secret level corresponding to the classification of the information received by the encryption data receiving portion, an information storing portion for storing the information encrypted by the encrypting portion, and a process information transmitting portion for transmitting the process information about the encryption performed by the encrypting portion to the encryption support system.

In a preferred embodiment, the rule information indicates the rule including an encryption system that is used for encryption and a valid term of an encryption key that is used for the encryption. If a period since the information management system encrypted information until the present time exceeds the valid term relevant to the rule of the secret level corresponding to the classification of the information, the warning portion warns the information management system. If the encryption system that is indicated in the rule information is changed, the encryption data transmitting portion transmits the encryption data for performing encryption with the changed encryption system to the information management system, and the warning portion warns to perform encryption of information in accordance with the changed encryption system.

In another preferred embodiment, a valid term managing portion for managing a valid term of a certification for affixing an electronic signature to information is provided, and the monitoring portion monitors whether or not it is necessary to reaffix the electronic signature to the information in accordance with the valid term of the certification. The warning portion warns the information management system for managing the information to reaffix the electronic signature if it is decided that it is necessary to reaffix the electronic signature.

In another preferred embodiment, the information management system is provided with a classification secret level transmitting portion for transmitting classification secret level information that indicates classification of information managed by the information management system and the secret level corresponding to the classification to the encryption support system. Then, the monitoring portion performs the monitoring by comparing the process information received from the information management system with the classification secret level information.

### BRIEF DESCRIPTION OF THE DRAWINGS

FIG. 1 is a diagram showing an example of a structure of a security system according to the present invention.

FIG. 2 is a diagram showing an example of a hardware structure of a classified information server.

FIG. 3 is a diagram showing an example of a functional structure of the classified information server.

FIG. 4 is a diagram showing an example of a functional structure of a policy management server.

FIG. 5 is a diagram showing an example of an encryption rank table.

FIG. 6 is a diagram showing an example of a classified information group table.

FIG. 7 is a diagram showing an example of a division member table.

FIG. 8 is a diagram showing an example of a signature expiration date table.

FIG. 9 is a diagram showing an example of a generated data management table.

FIG. 10 is a diagram showing an example of an exception attribution table that a system management division has.

FIG. 11 is a diagram showing an example of an exception attribution table that a certain sales station has.

FIG. 12 is a diagram showing an example of a customer address table.

FIG. 13 is a diagram showing an example of a meter read information table.

FIG. 14 is a diagram showing an example of a payment account table.

FIG. 15 is a diagram showing an example of a procedure of a process for encryption and an electronic signature.

FIGS. 16A and 16B are flowcharts for explaining an example of process flows of the encryption and the electronic signature.

FIG. 17 is a flowchart for explaining an example of a process flow of preparation at the system management division side.

FIG. 18 is a flowchart for explaining an example of a process flow of preparation at the sales station side.

FIG. 19 is a flowchart for explaining an example of a process flow after starting operation.

FIG. 20 is a flowchart for explaining an example of a process flow in the classified information server when a request for access to the classified information is made.

FIG. 21 is a flowchart for explaining an example of a process flow in the classified information server when a change is made in various setting.

### DESCRIPTION OF THE PREFERRED EMBODIMENTS

Hereinafter, the present invention will be explained more in detail with reference to embodiments and drawings.

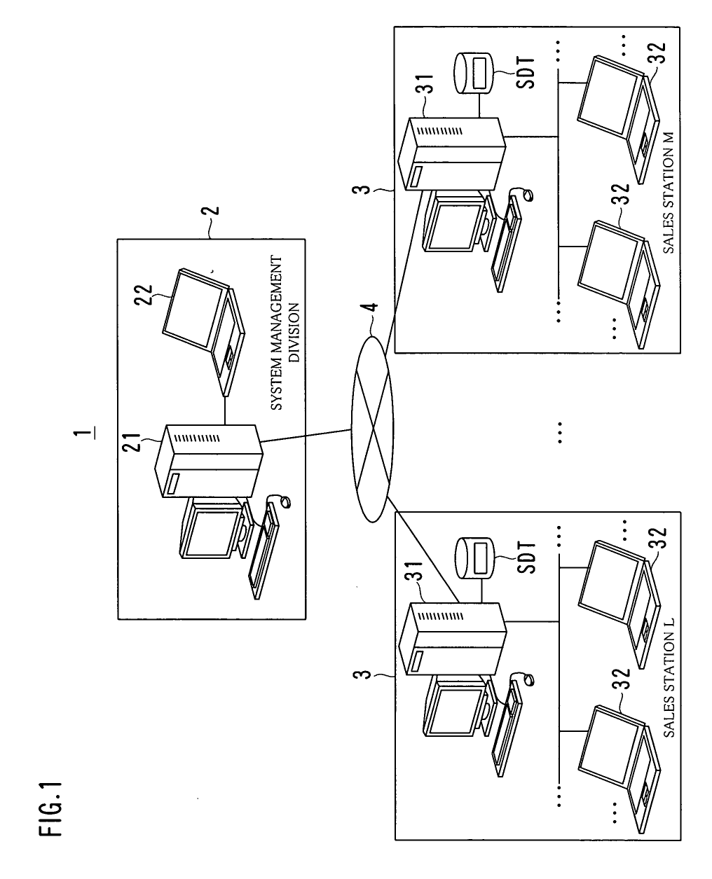

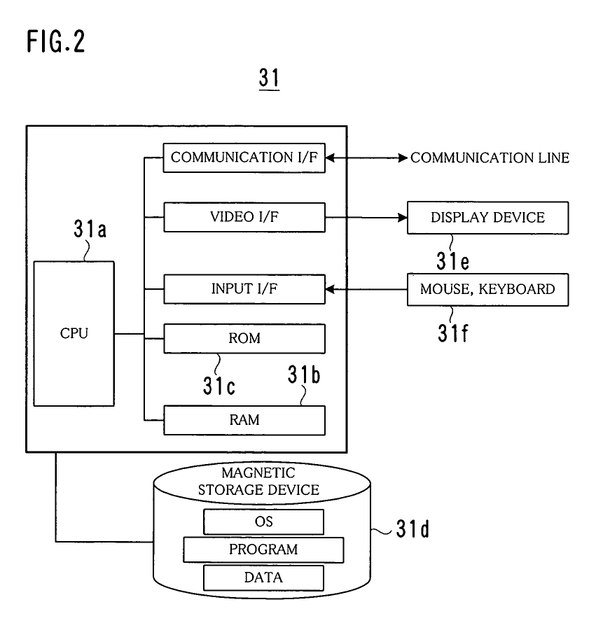

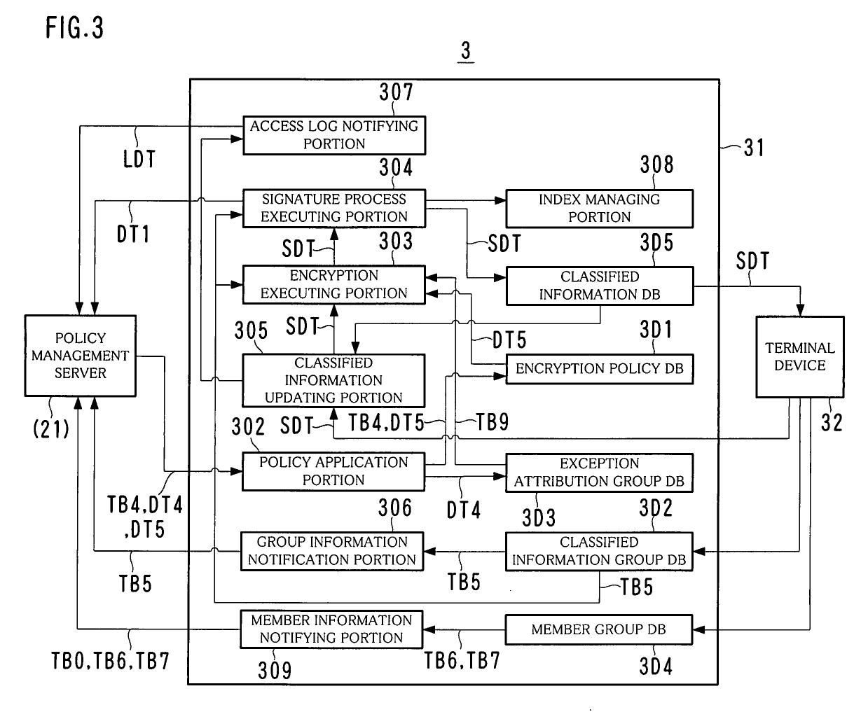

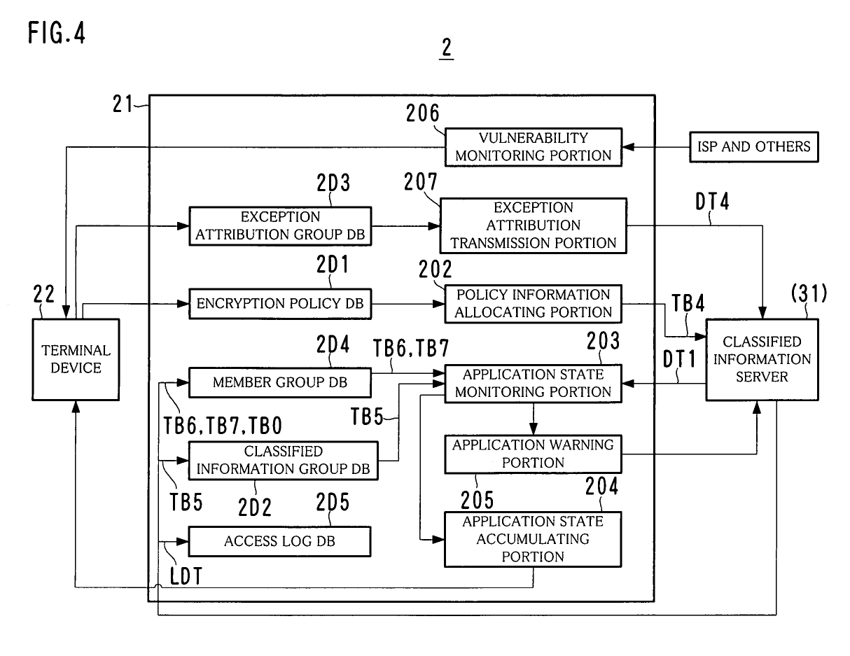

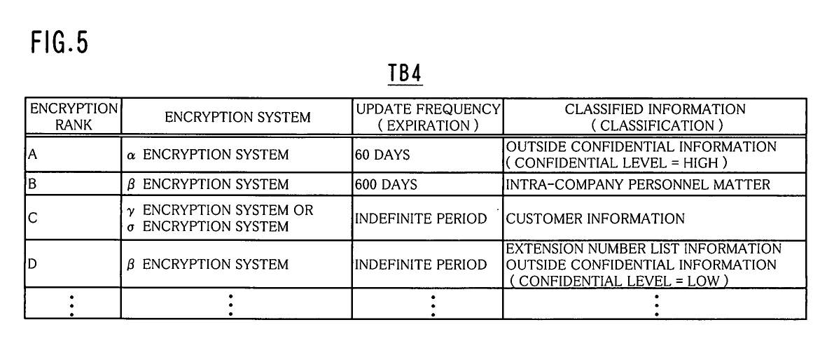

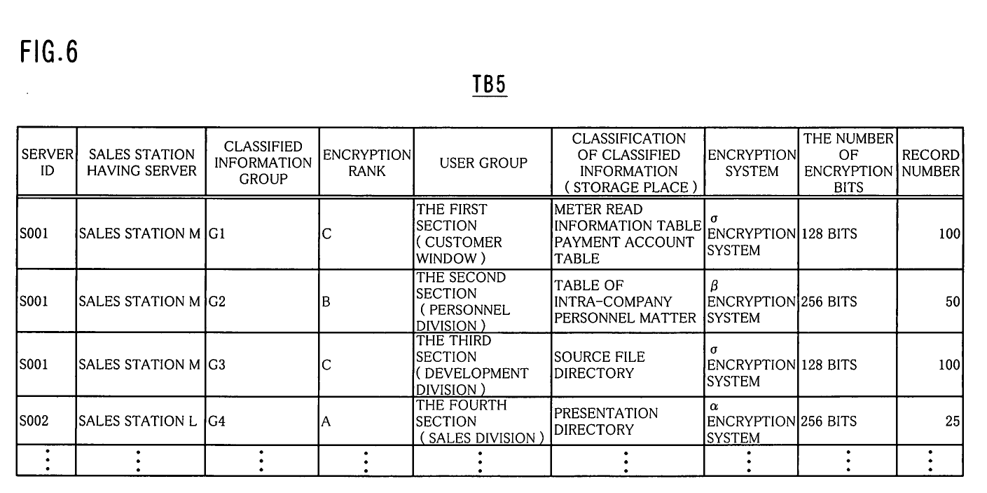

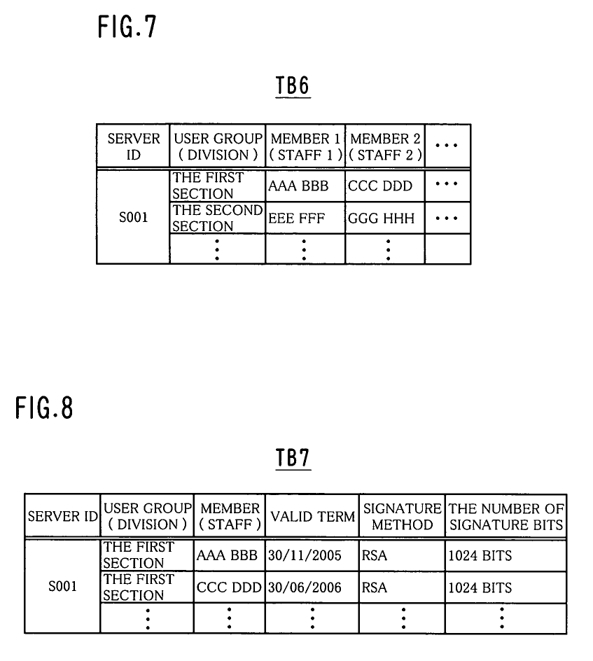

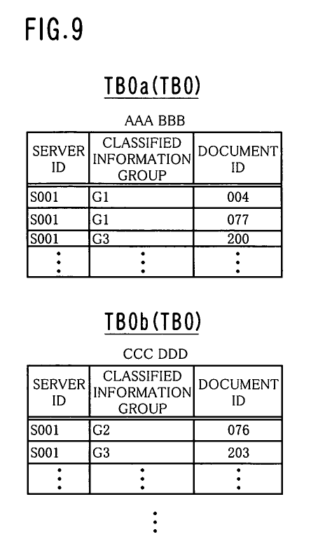

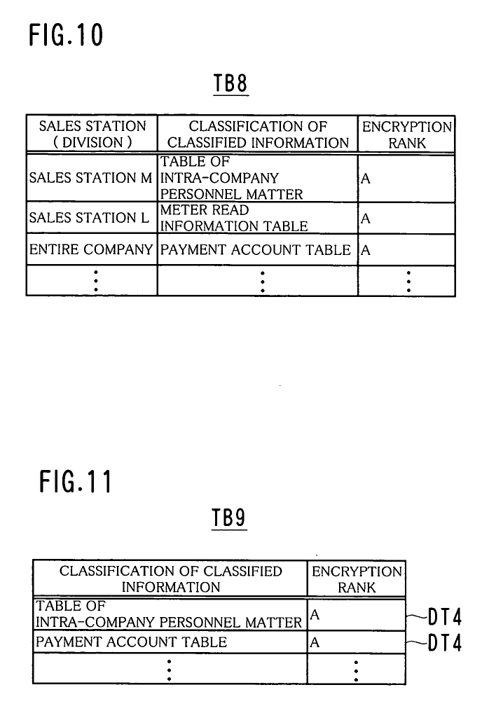

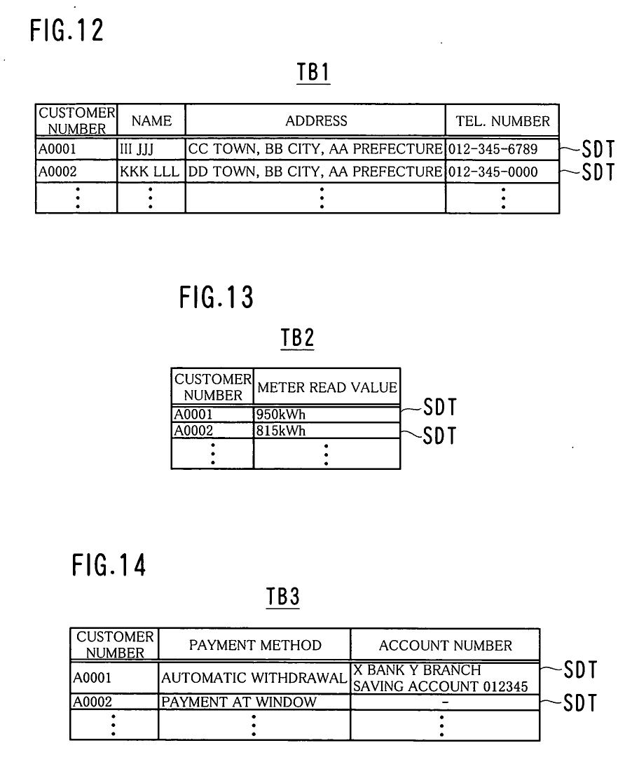

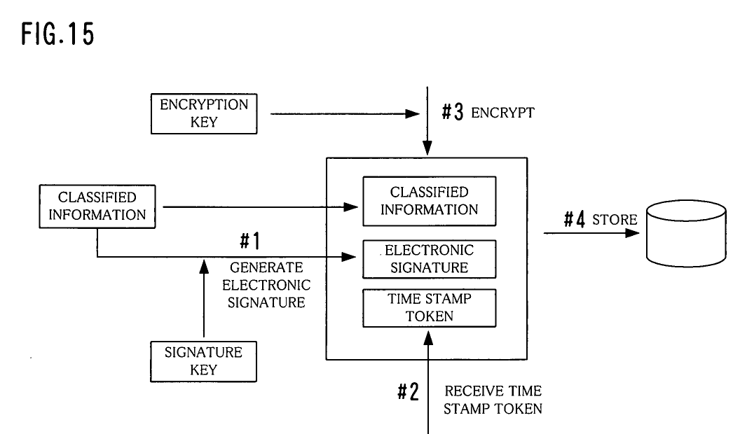

FIG. 1 is a diagram showing an example of a structure of a security system 1 according to the present invention. FIG. 2 is a diagram showing an example of a hardware structure of a classified information server 31. FIG. 3 is a diagram showing an example of a functional structure of the classified information server 31. FIG. 4 is a diagram showing an example of a functional structure of a policy management server 21. FIG. 5 is a diagram showing an example of an encryption rank table TB4. FIG. 6 is a diagram showing an example of a classified information group table TB5. FIG. 7 is a diagram showing an example of a division member table TB6. FIG. 8 is a diagram showing an example of a signature expiration date table TB7. FIG. 9 is a diagram showing an example of a generated data management table TB0. FIG. 10 is a diagram showing an example of an exception attribution table TB8 that a system management division has. FIG. 11 is a diagram showing an example of an exception attribution table TB9 that a certain sales station M has. FIG. 12 is a diagram showing an example of a customer address table TB1. FIG. 13 is a diagram showing an example of a meter read information table TB2. FIG. 14 is a diagram showing an example of a payment account table TB3. FIG. 15 is a diagram showing an example of a procedure of a process for encryption and an electronic signature.

The security system 1 according to the present invention includes an encryption support system 2, a classified information management system 3, and a network 4 as shown in FIG. 1. The encryption support system 2 and the classified information management system 3 can be connected to each other via the network 4. As the network 4, an intranet, the Internet, a public network or a private line can be used. In addition, it is desirable that authentication is established between the encryption support system 2 and the classified information management system 3.

This security system 1 is provided to a company including plural divisions such as sales stations or branches, or to a government organization including plural divisions such as branches or local offices. Hereinafter, an example of a security system 1 will be explained, which is provided to a company X including plural sales stations.

The classified information management system 3 includes a classified information server 31 and a terminal device 32. This classified information management system 3 is provided to each sales station for managing various classified information (confidential information) such as customer information of the sales station, information about technology under researching and developing, know-how about sales activity, a research report about competitors, financial information and personnel information.

The classified information is processed with encryption and an electronic signature. In addition, the classified information is managed in the classified information server 31 as a text file or a binary file that was made by a text editor, word processing software, spreadsheet software, or graphic software. Otherwise, it is managed as a record of a database (see FIGS. 12, 13 and 14). Hereinafter, the file or the record that is data of classified information is referred to as “classified data SDT”.

The classified information server 31 includes a CPU 31a, a RAM 31b, a ROM 31c, a magnetic storage device 31d, a display device 31e, an input device 31f such as a mouse or a keyboard, and various interfaces as shown in FIG. 2. The magnetic storage device 31d stores programs and data for realizing an operating system (OS) and functions that will be explained later. The program and data can be delivered via a recording medium such as a CD-ROM, or via the network 4 by the policy management server 21. Then, they are loaded into the RAM 31b as necessary so that the program can be executed by the CPU 31a.

By the above-mentioned structure, the classified information server 31 can realize functions of a policy application portion 302, an encryption executing portion 303, a signature process executing portion 304, a classified information updating portion 305, a group information notification portion 306, an access log notifying portion 307, an index managing portion 308, a member information notifying portion 309, an encryption policy database 3D1, a classified information group database 3D2, an exception attribution database 3D3, a member group database 3D4, and a classified information database 3D5 as shown in FIG. 3.

One or a plurality of the terminal device 32 is arranged at each division of the sales station so that a staff member who belongs to the sales station can handle the classified information. However, each staff member has the authority to use the classified information (an access right). This will be explained later.

The encryption support system 2 includes a policy management server 21 and a terminal device 22. This encryption support system 2 is administrated by the system management division that controls the system of the company X. The policy management server 21 performs a process concerning support for security control of the classified data SDT that is undertaken by the classified information management system 3 in each sales station. The terminal device 22 is used for an administrator in the system management division to operate the policy management server 21. It is sufficient that the system management division is authorized to control or manage the security, and it is not important that it is a full-time job or a part-time job.

The policy management server 21 has a hardware structure that is similar to that of the classified information server 31 as shown in FIG. 2. The policy management server 21 realizes functions of a policy information allocating portion 202, an application state monitoring portion 203, an application state accumulating portion 204, an application warning portion 205, a vulnerability monitoring portion 206, an exception attribution transmission portion 207, an encryption policy database 2D1, a classified information group database 2D2, an exception attribution database 2D3, a member group database 2D4, and an access log database 2D5 as shown in FIG. 4.

Hereinafter, functions of the classified information server 31 as shown in FIG. 3 and the policy management server 21 as shown in FIG. 4 will be explained while separating the functions into the function for controlling security of the classified data SDT and the function for preparing so as to realize it.

[Function for Preparing Security Control]

The company X has established an encryption policy as part of the company's security measure (a security policy) and a personal information protection measure (a personal information protection policy). An “encryption policy” means a rule, an agreement and a measure to be adopted when encrypting classified information data (classified data SDT). The company X has defined several ranks (levels) corresponding to importance or a confidential level of the classified information as the company's encryption policy. Hereinafter, this is referred to as an “encryption rank”. The rule of encryption is defined for each of the encryption ranks.

For example, as shown in FIG. 5, an encryption system and an update frequency are defined as the encryption rule for each of the encryption ranks A, B, . . . . The “encryption system” is an encryption technique that is used for encrypting the classified data SDT. For example, DES (Data Encryption Standard), 3DES, FEAL (Fast Data Encipherment Algorithm), IDEA (International Data Encryption Algorithm), or RSA (Rivest Shamir Adleman) is used as the encryption technique. The “update frequency” means a frequency, i.e., a period for performing the encryption again. For example, if it is defined as “60 days”, a new encryption key is generated every period within 60 days so that the encryption is performed again with the encryption key.

In this embodiment, the rank (level) of the “encryption rank” as shown in FIG. 5 shows a tendency that the difficulty in decrypting the code increases in the order A, B, . . . , as a whole, but it does not always show the difficulty in decrypting the code. As explained above, the encryption rank in this embodiment is used for distinguishing an encryption rule that is a combination of the “encryption system”, the “update frequency” and others. Of course, it is possible to use the encryption rank as what shows the difficulty in decrypting the code in another embodiment.

The administrator of the policy management server 21 (the system management division) inputs the encryption rule of each encryption rank by operating the terminal device 22 and makes the encryption rank table TB4 as shown in FIG. 5. On this occasion, it is decided which encryption rank rule is used for encrypting the classified data SDT of each classified information that is handled in the company X. Then, the name of the classification (an attribution, a class) of the classified information that belongs to each encryption rank is designated to a field of the “classified information”. In this embodiment, a table or a directory that is a storage place of the classified data SDT of the classified information is used for classification of the classified information.

The encryption policy database 2D1 as shown in FIG. 4 stores the generated encryption rank table TB4 to manage. In addition, it stores encryption data DT5 that are necessary for encryption for each encryption system (α, β, . . . ) in accordance with the encryption system. As a form of the encryption data DT5, there is a main program file for performing the encryption system or a data file (a so-called library) of functions or values that are used by the encryption system.

The policy information allocating portion 202 allocates information of the encryption policy of the company X by transmitting the encryption rank table TB4 and the encryption data DT5 to the classified information server 31 of each sales station. When the content of the encryption rank table TB4 is updated, a new encryption rank table TB4 is allocated. In this case, it is possible to allocate only the portion (the record) that is updated. In addition, when the encryption data DT5 is updated or added, the new encryption data DT5 are allocated to each classified information server 31.

The policy application portion 302 shown in FIG. 3 makes the encryption policy database 3D1 store the encryption rank table TB4 that was sent from the policy management server 21, so that the encryption data DT5 is stored in a predetermined directory. Namely, the program and the data are installed so that the encryption policy of the company X is applied to the classified information server 31 and that the encryption process can be performed in accordance with the encryption policy. If the record of the updated encryption data DT5 or the encryption rank table TB4 is received, the corresponding old encryption data DT5 or record is replaced with it.

The classified information group database 3D2 stores the classified information group table TB5 as shown in FIG. 6 and manages the same. The server ID is used for distinguishing a device that stores the classified data SDT, i.e., the classified information server 31. Classified information groups G1, G2, . . . are respectively groups of classification of classified data SDT that are managed by the classified information server 31 and have the same user group (division) to which authority to use is given and the same encryption rank.

For example, it is understood from a first record of the classified information group table TB5 (the server ID=S001, the classified information group=G1) that the classified data SDT of the classified information that is stored in the payment account table TB3 of the sales station M (see FIG. 14) and the meter read information table TB2 (see FIG. 13) are encrypted by the encryption system that corresponds to “encryption rank=C” and that staff members of the first section (a division for a customer window) are authorized to use them. It is defined which classified information belongs to which classified information group for each sales station in accordance with the encryption policy that is described in the encryption rank table TB4 obtained from the policy management server 21 (see FIG. 5).

There is a case where plural encryption systems correspond to one encryption rank like “rank=C” in the encryption rank table TB4. In this case, the manager of the sales station may select one of the encryption systems in accordance with convenience of using the classified information, so as to designate the same in the classified information group table TB5. It is also possible to select one of the encryption systems automatically in accordance with an environment of the classified information management system 3 (for example, set information of the network of the classified information management system 3, ruggedness of the OS of the classified information server 31, or frequency of use of the classified information). Alternatively, concerning the classified information having plural encryption ranks like “outside classified information”, the manager of the sales station may select one of the encryption ranks for each classified information in accordance with stealthiness or importance of the classified information.

The “number of encryption bits” of the classified information group table TB5 indicates a size of the encryption key that is used for encrypting the classified information group by the encryption system. The “number of records” is a total number of the classified data SDT of the items (classifications) that belong to the classified information group.

The group information notifying portion 306 shown in FIG. 3 transmits the classified information group table TB5 defined as mentioned above to the policy management server 21, so that the system management division is informed how to encrypt classified data SDT of each classified information. Namely, a local encryption policy of the sales station is informed. The classified information group database 2D2 shown in FIG. 4 stores the classified information group table TB5 that was transmitted from each sales station and manages the same.

The member group database 3D4 shown in FIG. 3 stores the division member table TB6 shown in FIG. 7, the signature expiration date table TB7 shown in FIG. 8 and the generated data management table TB0 (TB0a, TB0b, . . . ) shown in FIG. 9 and manages them.

The division member table TB6 includes a table of users of the classified information server 31, i.e., staff members of each division of the sales station. The signature expiration date table TB7 includes information that indicates a valid term of the signature key for the electronic signature of each staff member. The generated data management table TB0 is provided for each staff member and includes a document ID of a document (classified data SDT) to which the staff member has signed.

The member information notifying portion 309 transmits the division member table TB6, the signature expiration date table TB7 and the generated data management table TB0 to the policy management server 21, so that the system management division is notified of the information of the staff members in the sales station. The member group database 2D4 shown in FIG. 4 stores the division member table TB6, the signature expiration date table TB7 and the generated data management table TB0 that was transmitted from each sales station and manages them.

As explained above, the rule for encrypting classified data SDT is defined by the classified information group table TB5 shown in FIG. 6 for each sales station. The system management division (the encryption support system 2) can define exceptions of this encryption rule by the exception attribution table TB8 shown in FIG. 10.

For example, as shown in the encryption rank table TB4 in FIG. 5, the encryption policy of the company X defines that each sales station has to set “encryption rank=B” concerning classified data SDT of classified information about intra-company personnel matter. Accordingly, in a certain sales station (for example, the sales station M), the encryption rank of the classified data SDT included in the information table of the intra-company personnel matter is set to “B” as shown in FIG. 6. However, the system management division can set an exception of this rule like the exception attribution table TB8 shown in FIG. 10, in which “encryption rank=A” is set for the information table of the intra-company personnel matter in the sales station M. In addition, without being limited to designation of one sales station unit, plural sales stations can be designated as a unit like a “payment account table” of the “entire company”. Thus, an encryption rank of classification of classified information that is common to plural sales stations can be set temporarily at the same time.

Such setting of exceptions may be done in the following cases, for example. One is the case where a security hole is found in the classified information management system 3 of the sales station. Another is the case where a risk of an unauthorized access to specific classified data SDT has increased when the password or the encryption key of the staff member of the sales station had leaked. Another is the case where it is considered that the state occurs where the security of the classified data is not maintained for a specific sales station or an unspecified sales station when an unauthorized access has really performed. In this way, the security can be enhanced efficiently.

This exception attribution table TB8 is stored and managed by the exception attribution database 2D3 shown in FIG. 4. Then, each record that indicates an exception is transmitted as exception information DT4 to a sales station that is given the exception by the exception attribution transmission portion 207. The exception attribution database 3D3 of each sales station (see FIG. 3) stores the exception information DT4 that was received in the exception attribution table TB9 and manages the same. For example, the received exception information DT4 is stored in the sales station M as shown in FIG. 11.

The classified information database 3D5 stores the classified data SDT of the classified information as a record in the table and manages the same. Otherwise, it is stored as a file in a predetermined directory of the magnetic storage device 31d (see FIG. 2) and is managed. For example, if the company X is an electric power supplying company, classified data SDT that indicate addresses of customers who receive a service such as a power supply are stored in the customer address table TB1 shown in FIG. 12. The meter read information table TB2 shown in FIG. 13 stores classified data SDT that indicate an electrical energy amount (a meter read value) used by the customer. The payment account table TB3 shown in FIG. 14 stores classified data SDT about a method of paying electricity rate. These classified data SDT are managed after being processed with the encryption and the electronic signature as follows.

[Functions for Security Control (Encryption and Electronic Signature)]

The encryption executing portion 303 and the signature process executing portion 304 look up the classified information group table TB5 shown in FIG. 6 and the exception attribution table TB9 shown in FIG. 11 for respectively performing the process of encrypting the classified data SDT and the process of the electronic signature. These processes are performed as shown in FIG. 15, for example.

The signature process executing portion 304 generates the electronic signature by the signature method that is set corresponding to an author or an approver of the classified data (#1) and receive a time stamp token (TST) (#2). The electronic signature is generated by compressing and encrypting the classified data SDT with a hash function, for example. As the hash function, MD5 (Message Digest Algorithm 5), SHA-1 (Secure Hash Algorithm 1) or HMAC (Hashed Based Message Authentication Code) can be used.

The encryption executing portion 303 look up the classified information group table TB5 that is shown in FIG. 6 and stored in the classified information group database 3D2 and encrypts the classified data SDT to which the electronic signature and the TST are attached (#3). For example, when storing a source file of a generated program in the source file directory as classified data SDT, a σ encryption system is used for the encryption.

However, if an exception of the encryption is set in the exception attribution table TB9 shown in FIG. 11 for the classified data SDT of the classified information, the classified data SDT is encrypted by the encryption system of the encryption rank indicated in the exception.

The encryption key that is used in Step #3 is stored in a recording medium such as a flexible disk and managed for each sales station or division, for example. Then, the encryption key is loaded into the classified information server 31 for use in every encryption. In addition, the signature key that is used for generating or updating the classified data SDT in person is used, which is usually stored in an IC card that is carried by the person.

The classified data SDT to which the electronic signature and the TST are attached for encryption is managed by the classified information database 3D5 (#4). When the processes of the encryption and the electronic signature are completed, process completion information DT1 that indicates completion of the process, the object of the process, the encryption system and the signature system that were used is sent to the policy management server 21. In addition, the “record number” of the classified information group table TB5 (see FIG. 6) is revised. In addition, a document ID of the classified data SDT is added to the generated data management table TB0 (see FIG. 9) of the person who is the author of the classified data SDT.

With reference to FIG. 3 again, the classified information updating portion 305 performs the process for updating the classified data SDT that are contents of the classified information managed by the classified information database 3D5. First, the encrypted classified data SDT is decoded, and the contents are displayed on the display device of the terminal device 32. An operation for revising the contents by the staff member is accepted. Then, an instruction is given to the encryption executing portion 303 and the signature process executing portion 304 so as to perform the processes of the encryption and the electronic signature. Thus, the process shown in FIG. 15 is performed again for the updated classified data SDT. This classified data SDT replaces the classified data SDT before the update. If revising (updating) is not performed, i.e., if only browsing of the classified information is performed, the decoded classified data SDT are erased after the browsing, and the original classified data SDT are remained.

The access log notifying portion 307 notifies the policy management server 21 of log information LDT about the access date, the classified information group to which the classified data SDT belong and the staff member who did the access when the access to the classified data SDT is performed. For example, when contents of the classified data SDT are revised (updated) or browsed, the log information LDT is notified. In addition, when the access was tried but failed, the log information LDT that indicates the fact is notified.

The access log database 2D5 shown in FIG. 4 stores and manages the log information LDT that is received from the classified information server 31 of each sales station. In this case, an identification code is assigned to each sales station, and the log information LDT is set to correspond to the identification code of the sales station that made the transmission. The log information LDT can be used for identifying a person who made an unauthorized access to the classified data SDT, for example.

The index managing portion 308 shown in FIG. 3 generates and manages an index about the encrypted classified data SDT stored in each table managed by the classified information database 3D5 (see FIGS. 12, 13 and 14) and in each directory. For example, an index indicating a table name or a directory name indicating a place where the classified data SDT are stored, the encryption system, the signature system, the author or the reviser, or a date of creation or update is generated and managed.

The application state monitoring portion 203 shown in FIG. 4 monitors a state of applying the encryption policy in the classified information server 31 of each sales station. The monitoring is performed by comparing the process completion information DT1 that was received from the classified information server 31 of the sales station with the classified information group table TB5 (see FIG. 6) and the exception attribution table TB8 (see FIG. 10) of the sales station.

For example, if it is confirmed that all of the process completion information DT1 corresponding to the classifications of all classified information designated by the classified information group table TB5 are prepared, and the process completion information DT1 indicates the encryption system and the signature system designated by the classified information group table TB5, then it is decided that the encryption policy is used correctly. If it is confirmed that all of the process completion information DT1 are not prepared after a predetermined period has passed or that the process was performed in a system different from the designated encryption system or the designated signature system, then it is decided that the encryption policy is not used correctly. However, even if the process was performed in a system different from the designated encryption system, as long as the process is performed in accordance with the exception indicated by the exception attribution table TB8, it is decided that the encryption policy is used correctly.

The application state accumulating portion 204 accumulates the result of monitor by the application state monitoring portion 203 so as to display on the display device or to print on a paper sheet as a report for informing a manager in the system management division, a manager in each sales station or others.

The application warning portion 205 warns the sales station by transmitting a message that orders to use the encryption policy correctly without delay when it is decided that the encryption policy is not used correctly.

The application state monitoring portion 203 monitors the period for performing the encryption as shown in the encryption rank table TB4 in FIG. 5 (the update frequency) and the valid term of the certification that is used for the electronic signature as shown in the signature expiration date table TB7 in FIG. 8 (hereinafter simply referred to as “the electronic signature”). Then, if the time indicated in the “update frequency” field has passed since the time when the encryption was performed before, the application warning portion 205 warns to perform the encryption again of the classified data SDT of the corresponding classified information. If the valid term of the electronic signature has past, warning is performed that orders to attach a new electronic signature to the classified data SDT of the corresponding classified information. It is possible to transmit a message of notice before a predetermined period before (e.g., a week before) the period for encryption or the term.

The vulnerability monitoring portion 206 obtains technical information about the encryption and the electronic signature from an organization that provides a service about networks (such as a computer manufacturer, a communication device manufacturer, an internet service provider or a security service company), so as to perform monitoring about vulnerability of the encryption and electronic signature that are used in the classified information management system 3. Namely, it is monitored whether or not the encryption system that is used currently is appropriate. The technical information is provided as a vulnerability defining file, for example. The monitor of the vulnerability is performed by matching the contents of the vulnerability defining file with an encryption system that is defined by the encryption rank table TB4 shown in FIG. 5.

If vulnerability is found, a warning is given to a manager of the system management division. Then, the manager may take a measure promptly for eliminating the vulnerability. For example, a caution may be issued to managers of the sales stations, or a level of the encryption may be raised, or the encryption key may be changed, or a new encryption system may be adopted. In addition, the policy information allocating portion 202 delivers a new encryption data DT5 or encryption rank table TB4 (see FIG. 5) to each classified information management system 3 for solving the vulnerability if necessary.

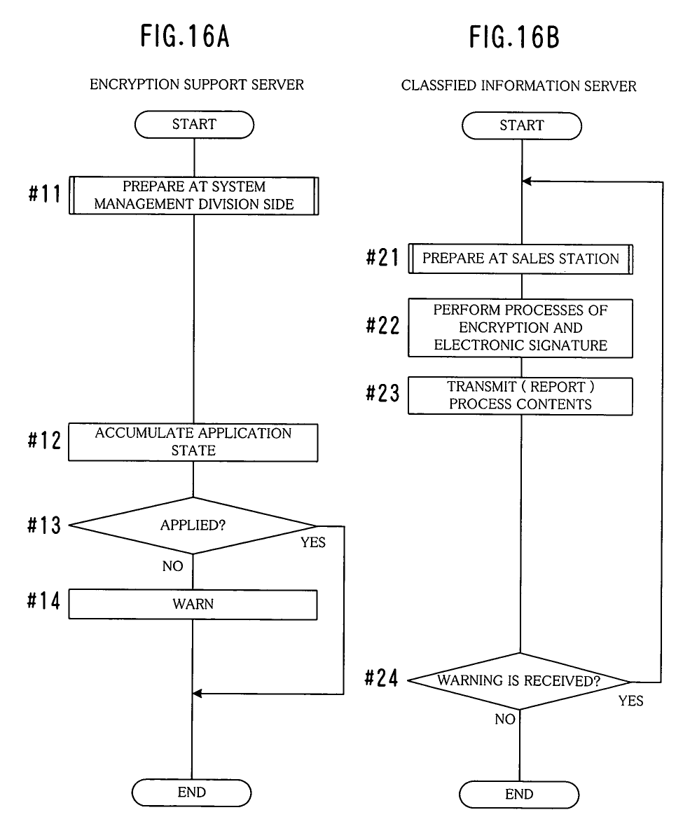

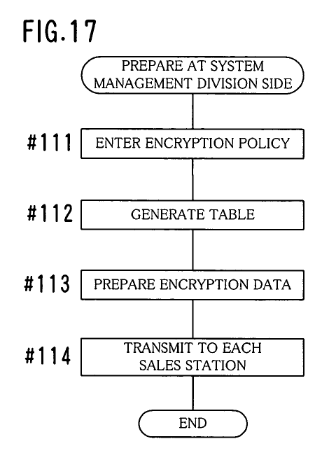

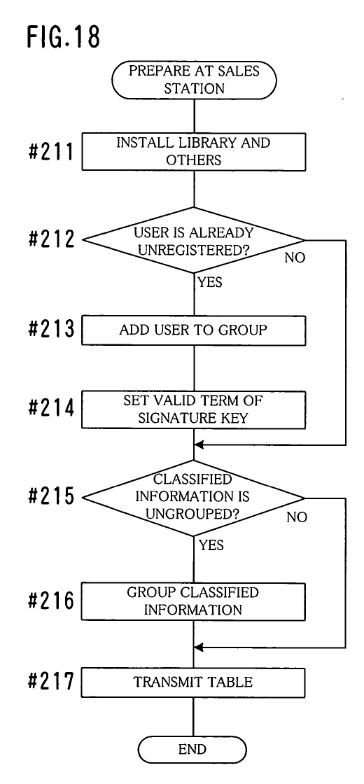

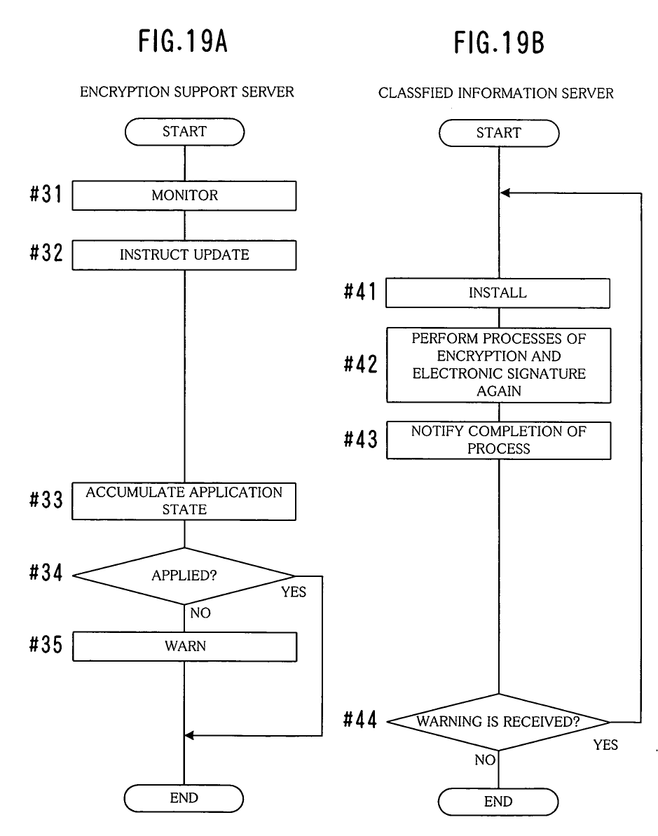

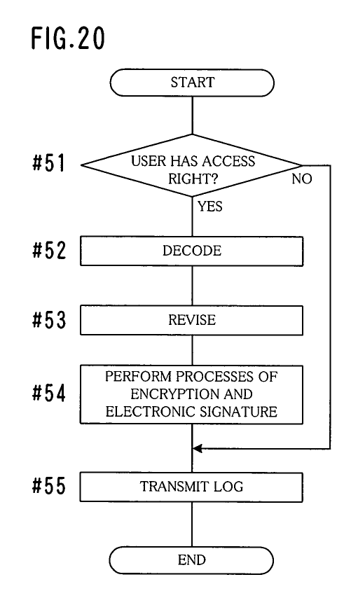

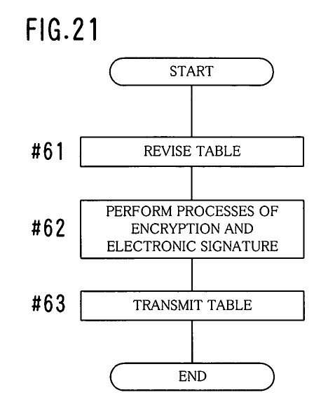

FIGS. 16A and 16B are flowcharts for explaining an example of process flows of the encryption and the electronic signature. FIG. 17 is a flowchart for explaining an example of a process flow of preparation at the system management division side. FIG. 18 is a flowchart for explaining an example of a process flow of preparation at the sales station side. FIG. 19 is a flowchart for explaining an example of a process flow after starting operation. FIG. 20 is a flowchart for explaining an example of a process flow in the classified information server 31 when a request for access to the classified information is made. FIG. 21 is a flowchart for explaining an example of a process flow in the classified information server 31 when a change is made in various setting.

Next, process flows in the policy management server 21 and the classified information server 31 will be explained with reference to the flowcharts. In order to realize a management of the classified information that is adapted to the security policy of the company X in each sales station, the policy management server 21 and the classified information server 31 perform processes in the procedures shown in FIGS. 16A and 16B, respectively.

The policy management server 21 performs a preparation for supporting the encryption and the electronic signature of the classified data SDT of the classified information in each sales station (#11). Namely, as shown in FIG. 17, an encryption policy that was made in accordance with the security policy of the company X is entered (#111), so that the encryption rank table TB4 as shown in FIG. 5 is generated (#112). In addition, a main program and data such as libraries (the encryption data DT5) that are necessary for the processes of the encryption and the electronic signature are prepared (#113). Then, the encryption rank table TB4 and the encryption data DT5 are transmitted to the classified information server 31 in each sales station (#114).

On the other hand, the classified information server 31 prepares for the encryption and the electronic signature of the classified data SDT of the sales station (#21). Namely, as shown in FIG. 18, the encryption rank table TB4 and the encryption data DT5 that were sent from the policy management server 21 are installed (#211).

If there is a staff member who handles the classified information and is not registered in the division member table TB6 shown in FIG. 7 (Yes in #212), the staff member is added to the division member table TB6 (#213). In addition, the signature key is issued to the staff member, and the valid term included in the issued signature key is obtained, so that the valid term of the signature key is set in the signature expiration date table TB7 shown in FIG. 8 (#214).

Furthermore, if there is a classification of the classified information in which the encryption system and the signature system and the access right are not set (Yes in #215), they are set in the classified information group table TB5 shown in FIG. 6 (#216). Namely, the classified information group is set.

Then, the tables shown in FIGS. 6, 7 and 8 are transmitted to the policy management server 21, so that the information about the encryption rule and the staff member in the sales station is informed to the system management division (#217).

With reference to FIG. 16 again, the classified information server 31 performs the processes of the encryption and the electronic signature of the classified data SDT in accordance with the classified information group table TB5 shown in FIG. 6 (#22) and transmits the process completion information DT1 that indicates contents of the processes to the policy management server 21 (#23).

The policy management server 21 performs accumulation of the application state of the encryption policy in each sales station (#12). The accumulation is performed by comparing the process completion information DT1 that was received from the sales station with the classified information group table TB5 (see FIG. 6) and the exception attribution table TB8 (see FIG. 10). When the accumulation is completed for all sales stations, the result is displayed on the display device or printed as a report. It is possible to perform the accumulation only for a part of the sales stations.

If it is found from the result of the accumulation that the encryption policy is not applied yet after a predetermined period has passed (No in #13), a warning message is transmitted to the sales station (#14).

The classified information server 31 of the sales station that received the warning message performs the process in Steps #22 and #23 again so that the encryption policy is applied correctly (Yes in #24). If necessary, setting of the classified information group (see FIG. 6) or the user group (see FIG. 7) is performed again (#21). Then, if it is confirmed that the policy management server 21 uses the encryption policy (Yes in #13), the application of the encryption policy in the sales station is completed (No in #24).

After the application of the encryption policy is finished, the policy management server 21 performs monitoring of the encryption key that is used for the encryption and the valid term of the signature key that is used for the electronic signature (see FIGS. 5 and 8) and monitoring of vulnerability of the encryption system as shown in FIG. 19 (#31).

If it is found from the monitoring that the valid term of the encryption key or the signature key is expired, the sales station that is using the encryption key or the signature key is instructed to perform the process of the encryption or the electronic signature again (#32). It is possible to notice a predetermined period before the expiration of the valid term.

If vulnerability is found by the monitoring, a warning is given to each sales station. If necessary, it is instructed to perform the encryption or the electronic signature again, and the support for the process is performed (#32). Namely, new encryption data DT5 or a new encryption rank table TB4 (see FIG. 5) corresponding to the vulnerability is transmitted to each classified information server 31, which performs the encryption or the electronic signature again in accordance with the new encryption data DT5 or encryption rank table TB4. If vulnerability is found in a specific sales station, an exception of the encryption rank is set in the exception attribution table TB8, and content of the setting (see FIG. 11) is transmitted to the sales station.

The classified information server 31 in the sales station that received the instruction or the notice generates a new encryption key or signature key so as to perform the process of the encryption or the electronic signature again (#42). However, if it received the new encryption data DT5, the new encryption rank table TB4 or the exception of the encryption rank, it installs them (#41) before performing the process shown in Step #42. If the encryption rank table TB4 (see FIG. 5) has modified, the classified information group table TB5 (see FIG. 6) is revised if necessary, so that the process in Step #42 is performed based on the revised classified information group table TB5. Then, the completion of the process is notified to the policy management server 21 (#43).

The policy management server 21 accumulates the application state of the encryption policy similarly to Steps #12-#14 shown in FIG. 16A and warns the sales station that does not use the encryption policy correctly (No in #34 and #35). The classified information server 31 of the sales station that received the warning performs the process in Steps #41-#43 again (Yes in #44).

If there is a request for access to the classified data SDT of the encrypted classified information, the classified information server 31 decides whether or not the user (a staff member) who made the request has an access right in accordance with the classified information group table TB5 (see FIG. 6) as shown in FIG. 20 (#51).

If the staff member has the access right (Yes in #51), the classified data SDT is decoded and displayed for the staff member (#52). If the classified data SDT is revised (#53), the processes of the encryption and the electronic signature are performed for the revised classified data SDT (#54), and the log information LDT that indicates that the revision was made is transmitted to the policy management server 21 (#55). If the staff member does not have the access right (No in #51), the log information LDT that indicates that an access was tried is transmitted to the policy management server 21 (#55).

In order to change a classified information group of classified information or to change a location of a staff member in a sales station, a table shown in FIG. 6, 7 or 8 is revised as shown in FIG. 21 (#61). If necessary, the processes of the encryption and the electronic signature are performed again (#62). Then, the revised table is transmitted to the policy management server 21 (#63).

According to this embodiment, the system management division manages the information about the encryption and the electronic signature in a unified manner and monitors the application state of the encryption policy, so each division such as a sales station can manage one's own information so that a high level security can be maintained easily.

Furthermore, the conventional system has a possibility that information that is handled in an organization is tampered by an external unauthorized access. Also, there is a possibility that a staff member who belongs to the organization tampers information. On the contrary according to this embodiment, the process of the electronic signature is performed again if necessary, so that the tampering of information is more difficult than the conventional technique, resulting in enhancement of protection of the classified information. In this case, the timing of performing the process is managed by the system management division in a unified manner similarly to the case of the encryption, so the load of managing the system can be decreased in each sales station.

It is possible to use the security system 1 of this embodiment for an outsourcing system. For example, the encryption support system 2 may be installed in an outsourcing company that supports the information management, and a person who wants the support may prepare the classified information server 31. Thus, a small-scale company (a so-called SOHO) or an individual can obtain a high level security easily.

The structure of the entire or a part of the security system 1, the encryption support system 2, the information management system 3, the policy management server 21 and the classified information server 31, the contents of the tables, the encryption system, the signature system, the contents and order of the processes can be modified within the scope of the present invention.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. A security system comprising an information management system for managing information and an encryption support system for supporting encryption of information in the information management system,
the encryption support system including
an encryption rule storing portion for storing rule information that indicates an encryption rule of the information for each secret level that is a level of wanting to keep information secret,
an encryption data transmitting portion for transmitting encryption data that is necessary for encrypting information in accordance with the rule to the information management system,
a process information receiving portion for receiving process information that indicates the encryption process performed by the information management system from the information management system,
a monitoring portion for monitoring whether or not the encryption of information is performed in accordance with the rule by the information management system on the basis of the process information received from the information management system, and
a warning portion for warning the information management system that was found to encrypt information not in accordance with the rule by the monitoring portion to do encryption of information in accordance with the rule, and
the information management system including
an encryption data receiving portion for receiving the encryption data from the encryption support system,
a classification secret level storing portion for storing classification of information managed by the information management system in connection with the secret level for each of the classification,
an encrypting portion for encrypting information managed by the information management system by using the encryption data of the secret level corresponding to the classification of the information received by the encryption data receiving portion,
an information storing portion for storing the information encrypted by the encrypting portion, and
a process information transmitting portion for transmitting the process information about the encryption performed by the encrypting portion to the encryption support system.

2. The security system according to claim 1, wherein the rule information indicates the rule including an encryption system that is used for encryption and a valid term of an encryption key that is used for the encryption,
if a period since the information management system encrypted information until the present time exceeds the valid term relevant to the rule of the secret level corresponding to the classification of the information,
the warning portion warns the information management system,
if the encryption system that is indicated in the rule information is changed,
the encryption data transmitting portion transmits the encryption data for performing encryption with the changed encryption system to the information management system, and
the warning portion warns to perform encryption of information in accordance with the changed encryption system.

3. The security system according to claim 1, wherein the information management system includes
a classification secret level transmitting portion for transmitting classification secret level information that indicates classification of information managed by the information management system and the secret level corresponding to the classification to the encryption support system, and
the monitoring portion performs the monitoring by comparing the process information received from the information management system with the classification secret level information.

4. The security system according to claim 1, further comprising a valid term managing portion for managing a valid term of a certification for affixing an electronic signature to information, wherein
the monitoring portion monitors whether or not it is necessary to reaffix the electronic signature to the information in accordance with the valid term of the certification, and
the warning portion warns the information management system for managing the information to reaffix the electronic signature if it is decided that it is necessary to reaffix the electronic signature.

5. An information management system for managing information by receiving support for encrypting information, the support being provided by an encryption support system, comprising:
a receiving portion for receiving rule information that indicates an encryption rule of information defined for each secret level that is a level of wanting to keep information secret and encryption data that are necessary for encrypting information in accordance with the rule from the encryption support system;
a classification secret level storing portion for storing classification of information managed by the information management system for each classification in connection with the secret level;
an encrypting portion for encrypting information managed by the information management system by using the encryption data of the secret level corresponding to the classification of the information received by the receiving portion;
an information storing portion for storing the information encrypted by the encrypting portion; and
a process information transmitting portion for transmitting process information that indicates the encryption process performed by the encrypting portion to the encryption support system so as to receive a check whether or not the encryption of the information was performed in accordance with the rule.

6. An encryption support system for supporting an information management system for managing information to encrypt information, the encryption support system comprising:
an encryption rule storing portion for storing rule information that indicates an encryption rule of the information for each secret level that is a level of wanting to keep information secret;
a transmitting portion for transmitting encryption data that is necessary for encrypting information in accordance with the rule to the information management system;
a receiving portion for receiving process information that indicates the encryption process performed by the information management system from the information management system;
a monitoring portion for monitoring whether or not the encryption of information is performed in accordance with the rule by the information management system on the basis of the process information received from the information management system; and
a warning portion for warning the information management system that was found to encrypt information not in accordance with the rule by the monitoring portion to do encryption of information in accordance with the rule.

7. An encryption support system according to claim 6, further comprising a validity monitoring portion for monitoring validity of an encryption rule that is used currently in accordance with vulnerability information about vulnerability of security received from a security information providing portion, wherein
the transmitting portion transmits the encryption data for changing the rule appropriately to the information management system if it is decided that the encryption rule that is used currently has little validity.

8. A computer program product for use in a computer supporting encryption of information for an information management system that manages information, the computer program product comprising:
means for transmitting rule information that indicates an encryption rule of the information for each secret level that is a level of wanting to keep information secret and encryption data that is necessary for encrypting information in accordance with the rule to the information management system;
means for receiving process information that indicates the encryption process performed by the information management system from the information management system;
means for monitoring whether or not the encryption of information is performed in accordance with the rule by the information management system on the basis of the process information received from the information management system; and
means for warning the information management system that was found to encrypt information not in accordance with the rule by the monitoring means to do encryption of information in accordance with the rule.
